(19) United States
(12) Patent Application Publication
(10) Pub. No.: US 2011/0116673 A1
(43) Pub. Date: May 19, 2011

(54) Wireless Personal Audio Equipment

(76) Inventor: Marcus Lewis, Glewstone (GB)

(21) Appl. No.: 12/993,677

(22) PCT Filed: May 13, 2009
(86) PCT No.: PCT/GB09/01196

§ 371 Date: Jan. 12, 2011

(30) Foreign Application Priority Data
May 20, 2008 (GB) 0809144.9

(51) Int. Cl. H04R 1/10; A42B 1/02

(52) U.S. Cl. 381/376; 2/195.1

(57) ABSTRACT

A wireless personal audio equipment arrangement comprising: a hat, a control circuit including a microwave link receiver carried by the hat, the control circuit outputting signals to speakers, and acoustic chambers conducting sound signals produced by the speakers to earpieces carried by the hat.

### CROSS REFERENCE TO RELATED APPLICATION

This application is the United States national stage filing of PCT/GB2009/001196 entitled “Wireless Personal Audio Equipment” and filed May 13, 2009; which claims priority to Great Britain Patent Application GB0809144.9 entitled “Wireless Personal Audio Equipment” and filed May 20, 2008. Both of the aforementioned applications are incorporated herein by reference for all purposes.

### BACKGROUND OF THE INVENTION

This invention relates to wireless personal audio equipment.

It is commonplace for individuals to use hands-free devices to operate mobile telephones. Generally, these devices use either a wired connection or a microwave communications link, for example a Bluetooth link, between the hands-free device and the mobile telephone. Wired arrangements can be inconvenient. Some safety concerns have been expressed over the radiation from microwave communications links, particularly when located close to the head as in the case of a hands-free device, and when used for extended periods of time.

It is also commonplace for individuals to listen to music or other recorded media using headphones connected by wires or cables to a signal generating device in the form of, for example, a compact disc player, an MP3/4 or other file player, or the like. Sometimes, a mobile telephone device is used as the signal generating device. Although such arrangements provide a reasonably good audio signal, there are occasions where a user finds the wired connection between the headphones and the signal generating device to be inconvenient or undesirable.

Wireless arrangements are known which allow a user to avoid having the above mentioned wired connection between his headphones and the signal generating device. The wireless communications link between the signal generating device and the headphones is typically in the form of a microwave link, for example a Bluetooth link. Some concerns have been expressed over the safety of having microwave communications links close to the body, and particularly close to the head. Where used in connection with wireless audio equipment, there is the additional concern that the equipment may be in use for extended periods of time, thus potentially amplifying any safety risks.

Hence, for at least the aforementioned reasons, there exists a need in the art for advanced systems and methods for wireless personal audio equipment.

### BRIEF DESCRIPTION OF THE DRAWINGS

The invention will further be described, by way of example, with reference to the accompanying drawings, in which:

FIG. 1 is a perspective view of a wireless personal audio equipment arrangement in accordance with one embodiment of the invention;

FIGS. 2, 3 and 4 are top, underside and side views of the arrangement of FIG. 1;

FIG. 5 is a view illustrating part of the arrangement of FIG. 1 in greater detail; and

FIG. 6 illustrates a modification to the arrangement of FIGS. 1 to 5.

### BRIEF SUMMARY OF THE INVENTION

This invention relates to wireless personal audio equipment.

It is an object of the invention to provide a wireless personal audio equipment arrangement in which the disadvantages set out above are of reduced effect.

According to the present invention there is provided a wireless personal audio equipment arrangement comprising a hat, a control circuit including a microwave link receiver carried by the hat, the control circuit outputting signals to speakers, and acoustic chambers conducting sound signals produced by the speakers to earpieces carried by the hat.

An RF shield may be provided beneath the control circuit.

The speakers are conveniently mounted upon a circuit board carrying the control circuit.

It will be appreciated that by mounting the control circuit including the microwave link receiver on a hat, and providing an RF shield, the user's head can be shielded from radiation from the control circuit and microwave link receiver, thereby reducing safety concerns. Further, by using acoustic chambers to transmit the sound signals to earpieces, rather than using, say, wired connections to electrically operated speakers, additional unshielded electromagnetic irradiation can be avoided.

The RF shield is conveniently incorporated into a lining of the hat. Alternatively, or additionally, it may comprise a layer or coating associated with the control circuit or a housing thereof.

The equipment may be designed to be used simply in the playing of music or other audio signals, or alternatively may comprise a hands-free device for use with a mobile telephone device. Where used as a hands-free device, the microwave link preferably includes a transmitter, in addition to the receiver, and the hat preferably further carries a microphone connected to the control circuit in such a manner that sound signals picked up by the microphone can be converted to signals suitable for transmission to the mobile telephone device by the microwave link transmitter.

The hat conveniently comprises a baseball-type cap. In such an arrangement, the control circuit is preferably located on a central, front portion of the hat, and may carry a logo or other markings to enhance the visible appearance of the hat, for example on a housing associated therewith. Preferably, the hat includes a peak, control actuators being mounted upon the peak and electrically connected to the control circuit to allow a user to control the operation of the equipment. The actuators may control, for example, the output volume and latching of the microwave link to a signal generating device. In such an arrangement, the underside of the peak is preferably provided with an RF shield to further shield the user from radiation.

The equipment is preferably battery powered, for example by means of batteries located in a battery housing provided towards the rear of the hat. In such an arrangement, a wired connection will be provided between the battery housing and the control circuit to transmit electric power thereto.

This summary provides only a general outline of some embodiments of the invention. Many other objects, features, advantages and other embodiments of the invention will become more fully apparent from the following detailed description, the appended claims and the accompanying drawings.

### DETAILED DESCRIPTION

This invention relates to wireless personal audio equipment

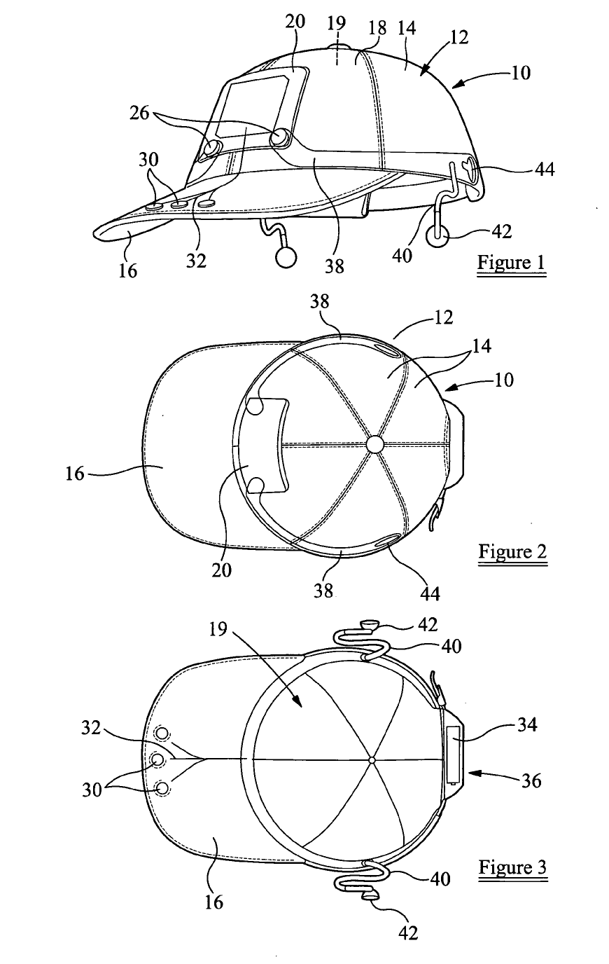

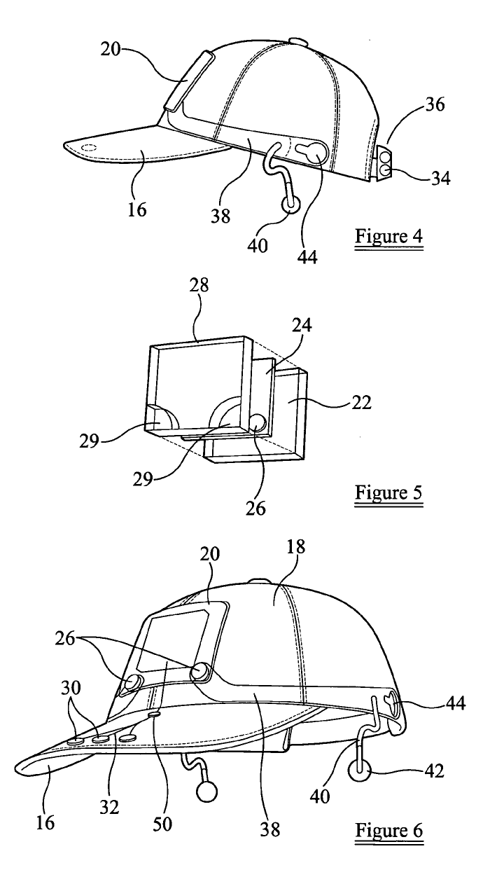

Referring to FIGS. 1 to 5 of the accompanying drawings there is illustrated a wireless personal equipment arrangement comprising a hat 10 in the form of a baseball-like cap. The hat 10 comprises a fabric region 12 formed from a series of generally triangularly shaped panels 14 which are sewn together. If desired, parts of the fabric region 12 may be provided with suitable linings and/or stiffeners. A peak 16 is mounted to the front of the region 12. The peak 16 comprises a stiffener, for example of polypropylene form sewn into a fabric cover.

Mounted upon a front part 18 of the region 12 is a circuit board module 20. As shown in FIG. 5, the module 20 comprises a polypropylene substrate 22 which is provided with an RF shielding coating. A circuit board 24 is mounted upon the substrate 22. The circuit board 24 includes circuits forming the receiver of a stereo microwave communications link, for example a so-called Bluetooth stereo link, circuits for converting the received signals into stereo output signals, and a pair of speakers 26 driven using the output signals. The speakers 26 are mounted upon the circuit board 24 in an orientation such that the audio signals produced thereby, in use, are transmitted upwardly and forwardly of the circuit board in the orientation in which the hat will normally be worn. A cover 28 overlies the circuit board 24, the cover 28 being shaped to define recesses overlying the speakers 26, the recesses forming cavities 29 in the assembled module 20. The module 20 is mounted upon the exterior of the front part 18 of the hat 10, and so is visible. In order to enhance the appearance of the equipment, the cover 28 may be provided with a logo or the like, thereby disguising the presence of and function of the module 20, if desired. The cover 28 may be provided with a suitable RF shield, if desired. However, it will be appreciated that in order for the equipment to operate, an antenna or aerial of the microwave communications link will need to be located outside of the RF shielding of the module 20 in order for signals to be received thereby.

The underside of the front part 18 of the region 12 is provided with an RF shielding lining 19, for example in the form of a Mylar substrate sewn to the interior of the hat 10. It will be appreciated that the RF shielding provided by the lining 19 and the parts of the module 20 reduce the exposure of the user to radiation originating from the control circuit, in use, thereby reducing safety concerns.

The peak 16 is provided with control actuators 30 in the form of button switches which are connected to the control circuit of the circuit board 24 by wires 32. The actuators 30 may be used, in combination with the operation of the control circuit, to control, for example, latching of the microwave link to a signal generating device and/or the volume of the output audio signals. If desired, other controls may be provided, for example to control the tone of the output audio signals.

The circuits carried by the circuit board 24 are electrically powered from a battery or batteries. Although arrangements may be possible in which the batteries are provided within or upon the module 20, in the illustrated embodiment the batteries 34 are located within a battery housing 36 provided at the rear of the hat 10, sewn to the rim thereof, and are electrically connected to the circuit board 24 by wires sewn into the hem/rim of the fabric part 12. The battery housing 36 is conveniently provided with an on/off power switch for use in controlling the operation of the equipment.

Sewn into the rim of the fabric part 12 are a pair of acoustic chambers 38, the chambers 38 being located on opposite sides of the hat 10. The chambers 38 are of elongate, substantially tubular form being open at one end and closed at an opposite end thereof. The open end of each acoustic chamber 38 is connected to the module 20, opening into a respective one of the cavities 29 thereof. The interior shape of the acoustics chambers 38 is designed so as to transmit audio signal generated by the speakers 26 with relatively little loss in volume or sound quality to sound tubes 40 connected adjacent the closed ends of the acoustic chambers 38. The sound tubes 40 are of flexible form, project through openings formed in the adjacent fabric material, and terminate at acoustic earpieces 42, preferably of waterproof form.

Adjacent the closed ends of the acoustic chambers 38, storage recesses 44 are formed into which the earpieces 42 can be inserted when not in use for storage thereof. The fabric material of the region 12 is formed with openings and is sewn around the recesses 44 to permit access thereto.

In use, a user wears the hat 10 upon his head, removes the earpieces 42 from the storage recesses 44 and places them in or adjacent his ears, switches on the power supply using the switch provided on the battery housing 36, and latches the microwave receiver to the microwave transmitter of a separate audio signal generating device using an appropriate one of the actuators 30 to form a microwave transmission link therebetween. Once latched to the signal generating device, audio signals transmitted by the signal generating device are received by the microwave receiver and converted to output signals by the control circuit. The output signals are used to drive the speakers 26, producing stereo sound signals which are transmitted along the acoustic chambers 38 and sound tubes 40 to the earpieces 42 to be heard by the user. The user can adjust the volume of the sound signals using appropriate ones of the actuators 30.

It will be appreciated that the RF shielding provided on the hat 10 and module 20 reduces the exposure of the user to radiation, thus safety risks are reduced. The use of acoustic chambers 38 to transmit sound signals to the earpieces, rather than, say, electrical cables transmitting signals to speakers mounted adjacent the users ears further reduces exposure to radiation.

FIG. 6 illustrates a modification to the arrangement of FIGS. 1 to 5. In the FIG. 6 arrangement, in addition to, or instead of, being intended for use in the playing of music or other audio information to a user, the equipment is adapted for use as a hands-free device for use in association with a mobile telephone device. To this end, a microphone 50 is carried by the peak 16 and electrically connected to the control circuit, and the microwave link is a two-way link, serving both as a receiver and a transmitter so as to allow incoming signals to be transmitted from the mobile telephone to control circuit, and to allow sounds signals picked up by the microphone to be transmitted to the mobile telephone for subsequent transmission thereby. The microphone is conveniently located close to the head, in use, in order to minimize wind interference, and also to keep cable lengths to a minimum.

In conclusion, the invention provides novel systems, devices, methods and arrangements for wireless personal audio equipment. While detailed descriptions of one or more embodiments of the invention have been given above, a wide range of modifications and alterations may be made to the arrangement described hereinbefore without departing from the scope of the invention. For example, the shapes and configurations of the component parts may be changed. Further, additional functionality may be provided, where desired. Therefore, the above description should not be taken as limiting the scope of the invention, which is defined by the appended claims.

What is claimed is:

1. A wireless personal audio equipment arrangement comprising a hat, a control circuit including a microwave link receiver carried by the hat, the control circuit outputting signals to speakers, and acoustic chambers conducting sound signals produced by the speakers to earpieces carried by the hat.

2. An arrangement according to claim 1, wherein an RF shield is provided beneath the control circuit.

3. An arrangement according to claim 2, wherein the RF shield is provided by a coating provided on a housing associated with the control circuit.

4. An arrangement according to claim 2 or claim 3, wherein the RF shield is provided, at least in part, by a layer provided in or on the hat.

5. An arrangement according to claim 4, wherein the RF shield is incorporated into a lining of at least part of the hat.

6. An arrangement according to any of the preceding claims, wherein the speakers are mounted upon a circuit board carrying the control circuit.

7. An arrangement according to any of the preceding claims, wherein the hat comprises a baseball-type cap.

8. An arrangement according to claim 7, wherein the control circuit is located on a central, front portion of the hat.

9. An arrangement according to claim 8, wherein the control circuit carries a logo or other markings to enhance the visible appearance of the hat.

10. An arrangement according to claim 8 or claim 9, wherein the hat includes a peak, control actuators being mounted upon the peak and electrically connected to the control circuit to allow a user to control the operation of the equipment.

11. An arrangement according to claim 10, wherein the actuators control or permit adjustment of the output volume and latching of the microwave link to a signal generating device.

12. An arrangement according to claim 10 or claim 11, wherein the underside of the peak is provided with an RF shield to further shield the user from radiation.

13. An arrangement according to any of the preceding claims, wherein the equipment is battery powered.

14. An arrangement according to claim 13, wherein the battery power is derived from batteries located in a battery housing provided towards the rear of the hat.

15. An arrangement according to claim 14, further comprising a power switch associated with the battery housing.

16. An arrangement according to any of the preceding claims, wherein the control circuit further includes a microwave link transmitter, and the equipment includes a microphone connected to the control circuit.

17. A wireless personal audio equipment arrangement substantially as hereinbefore described with reference to any of the accompanying drawings.
